(19) United States
(12) Patent Application Publication
(10) Pub. No.: US 2025/0029023 A1
(43) Pub. Date: Jan. 23, 2025

(54) REMOTE-SENSING YIELD ESTIMATION METHOD APPLICABLE TO CROP WHOLE GROWTH PERIOD

(71) Applicant: SHANDONG UNIVERSITY OF SCIENCE AND TECHNOLOGY, Qingdao (CN)

(72) Inventors: Zhenhai LI, Qingdao (CN); Shijun WANG, Qingdao (CN); Chengzhi FAN, Qingdao (CN); Jianguo WANG, Qingdao (CN); Xiaokang ZHANG, Qingdao (CN)

(21) Appl. No.: 18/757,684

(22) Filed: Jun. 28, 2024

(30) Foreign Application Priority Data
Jul. 18, 2023 (CN) 202310876336.3

(51) Int. Cl. G06Q 10/04; G06N 3/126; G06Q 50/02

(52) U.S. Cl. CPC G06Q 10/04; G06N 3/126; G06Q 50/02

(57) ABSTRACT

A remote-sensing yield estimation method is described that is applicable to a crop whole growth period and belongs to the field of data processing methods and photogrammetry technologies with prediction purpose. In the present disclosure, in combination with agricultural knowledge of crop yields and multi-source remote-sensing data, with the biomass estimation model of whole growth period, the biomass contribution rate curve and the crop harvest index as basis, a crop yield estimation model of whole growth period with stable spatiotemporal extensibility is constructed. The yield estimation model uses the relative accumulated temperature and the remote-sensing vegetation index as variable inputs. Further, based on genetic algorithm, the parameters of the model are optimized in a case of failing to directly construct the model with data fitting due to less sample points, so as to help solve the problems of poor spatiotemporal mobility of the yield estimation model.

### TECHNICAL FIELD

The present disclosure relates to the field of data processing methods with prediction purpose and photogrammetry technologies, and in particular to a remote-sensing yield estimation method applicable to a crop whole growth period.

### BACKGROUND

At present, there are three categories of crop yield remote-sensing estimation methods: 1. Statistics model: the model has strong operability and simple application. The patent CN110414738A discloses a crop yield prediction method and system in which an optimal yield prediction decision tree model is selected based on difference of predicted regions and can be applied to the yield prediction of crops in large regions, bringing up the yield prediction accuracy. 2. Crop model assimilation: the model is constructed based on physical mechanism of crop growth and development, with many parameters to be input. The patent CN108509836A discloses a crop yield estimation method of dual-polarized synthetic aperture radar and crop model data assimilation, which fully combines the advantages of SAR remote-sensing data and WOFOST model to increase the yield simulation accuracy of the crop model. 3. Semi-mechanistic model: compared with the mechanistic model, its structure is simplified. The patent CN109919395A discloses a winter wheat yield estimation method based on short-period remote-sensing region data, in which by using an improved CASA model, high spatiotemporal-resolution winter wheat NPP spatial distribution information with an interval of five days is estimated, and the winter wheat yield remote-sensing estimation can be achieved in combination with an NPP-yield conversion model. The current crop yield estimation models can achieve high estimation accuracy in a specific growth period of a crop, but usually have the problems of poor spatiotemporal mobility and difficult of application at the time of application to other crops or multiple growth periods, failing to performing pixel-scale dynamic monitoring for crop yield.

### SUMMARY

The object of the present disclosure is to provide a remote-sensing yield estimation method applicable to a crop whole growth period, so as to solve the problems of poor spatiotemporal mobility and difficult of application of the crop yield estimation models in the prior arts.

There is provided a remote-sensing yield estimation method applicable to a crop whole growth period, comprising:
S1: constructing a biomass remote-sensing drive model;
S2: constructing a biomass contribution rate curve;
S3: predicting crop yield; and,
S4: performing parameter optimization of optimization algorithm.

In the step S1, the biomass remote-sensing drive model is a layered structure, wherein in a first layer, a relationship model of an enhanced vegetation index EVI2 and biomass AGB is constructed; in a second layer, an evolution function is constructed with a coefficient of the first-layer model and a relative accumulated temperature of the growth period; a slope k of the first-layer model and the relative accumulated temperature RGS are in exponential law, and an intercept b and the RGS are in linear law, with the specific formula shown below:

$${AGB}_{i} = k * EVI 2 + b ; k = {k}_{1} \cdot {e}^{{b}_{1} \cdot RGS} ; \\ b = {k}_{2} * RGS + {b}_{2} ; EVI 2 = \frac{2.5 * ( NIR - R )}{1 + NIR + 2.4 * R}$$

wherein AGBᵢ refers to a crop biomass, k and b refer to a coefficient and an intercept of a first-layer regression equation of the biomass model of the whole growth period, wherein k and b are used as dependent variables of two regression equations respectively in the second layer of the model; EVI2 is an enhanced vegetation index which is a dependent variable of the first-layer model and calculated by a red band and a near-infrared band of remote-sensing images; NIR and R are a near-infrared band and a red band of remote-sensing images respectively; k₁, b₁, k₂ and b₂ refer to coefficients of two regression equations of the second layer respectively.

In the step S2, the biomass contribution rate curve is an allometric growth curve, with a horizontal axis being the relative accumulated temperature value and a vertical axis being a biomass contribution rate; by using the biomass of an image obtaining date and the biomass contribution rate curve, a crop harvest biomass is obtained as crop maximal biomass AGBₘₐₓ, wherein the crop maximal biomass AGBₘₐₓ and the biomass contribution rate are shown below:

$$β = \frac{{b}_{3}}{1 + {b}_{4} \times {e}^{{b}_{5} \cdot RGS}} ; {AGB}_{max} = \frac{AGB}{β}$$

wherein β is a biomass contribution rate, b₃, b₄, b₅ are model coefficients; AGBₘₐₓ is a crop final biomass; AGB is a biomass of crop in a growth period.

In the step S3, the crop yield is a biomass of the last day in the growth period multiplied by a harvest index; the harvest index is a harvest index of a region determined, with one county administrative region as unit, based on the characteristics of different crop varieties obtained from seed administration department or agriculture promotion department, wherein the yield prediction formula is as below:

$$Yield = {AGB}_{max} \times HI$$

in the formula, Yield refers to a crop yield and HI refers to a harvest index corresponding to a crop.

In the step S4, seven parameters k₁, b₁, k₂, b₂, b₃, b₄, b₅ and two independent variables VI and RGS of a crop remote-sensing yield estimation model are obtained, wherein VI refers to a remote-sensing vegetation index, and the seven parameters of the yield estimation model are optimized based on genetic optimization algorithm.

The step S4 comprises the following steps:
S4.1, performing parameter initialization and determining a parameter optimization range; using parameters of a CBA model built based on ground data as initial values of the parameters of the yield estimation model, wherein the CBA model is a biomass estimation model of a whole growth period;
S4.2 fitness calculation: when performing optimization on the parameters of the crop yield estimation model based on genetic algorithm, selecting a RMSE of a measured yield and a predicted yield as fitness function; during the optimization process of the model parameters, using RMSE minimization after performing yield estimation with the yield estimation model by using training data as optimization target:
calculating an individual fitness as below:

$$J = \sqrt{\frac{{\sum }_{i = 1}^{n} ( {Y}_{gai} - {Y}_{i} )}{n}}$$

wherein J is an individual fitness, n is a number of training samples, Y_{gai} is a yield estimation value of a sample point, and Y is a measured yield value of a sample point;
S4.3 iterative calculation: using the fitness function to perform fitness evaluation on an individual; based on a probability that the genetic algorithm is in direct proportion to the individual fitness, determining a chance that each individual in current population is passed down to a next-generation population, and based on a size of the individual fitness, performing reproduction, crossover and inheritance operations;
performing repetitive iterative operation on the model parameters; when adjacent iterations are <0.01 or reach a preset 500 iterations, ending iterative calculation; performing decoding on optimized individuals to obtain optimized model parameter values;
S4.4, crop yield estimation: bringing the obtained optimized parameter values into the yield estimation model, and with the relative accumulated temperature and the remote-sensing vegetation index EVI2 of a crop in any growth period as inputs, obtaining a yield estimation result by using the yield estimation model at different times.

Compared with the prior arts, the present disclosure has the following beneficial effects: the remote-sensing yield estimation model of whole growth period is a semi-mechanistic model having a mechanistic property. The model can perform crop yield estimation accurately in any crop growth period and also can perform averaging calculation on multiple yield estimation results of multiple growth periods, so as to further improve the yield estimation accuracy. The remote-sensing vegetation index used by the input variable of the yield estimation model is EVI2 which can effectively overcome the saturation phenomenon at the time of high vegetation coverage degree and reduce influence on the soil background. The present disclosure can be applied to multiple crops such as wheat and rice and the like. the crop final yield information obtained by performing inversion in different crop growth periods can be used to direct, in a timely manner, optimized cultivation to ensure grain yield increase and yield stability, which is of great significance for scientific formulation of import and export decisions, grain market prices and trades, agricultural insurance evaluation and application and smart agriculture application etc.

### BRIEF DESCRIPTIONS OF THE DRAWINGS

FIG. 1 is a flowchart of a CBA model of the present disclosure.

FIG. 2 is a theme diagram of rice yields of two regions.

### DETAILED DESCRIPTIONS OF EMBODIMENTS

In order to make the objects, technical solutions and advantages of the present disclosure clearer, technical solutions of the present disclosure will be fully and clearly described below. Apparently, the embodiments described herein are only some embodiments of the present disclosure rather than all embodiments. All other embodiments obtained by those skilled in the arts based on the embodiments of the present disclosure without carrying out creative work shall all fall within the scope of protection of the present disclosure.

There is provided a remote-sensing yield estimation method applicable to a crop whole growth period, which includes the following steps:
S1: constructing a biomass remote-sensing drive model;
S2: constructing a biomass contribution rate curve;
S3: predicting crop yield; and,
S4: performing parameter optimization of optimization algorithm.

In the step S1, the biomass remote-sensing drive model is a layered structure, wherein in a first layer, a relationship model of an enhanced vegetation index EVI2 and biomass AGB is constructed; in a second layer, an evolution function is constructed with a coefficient of the first-layer model and a relative accumulated temperature of the growth period; a slope k of the first-layer model and the relative accumulated temperature RGS are in exponential law, and an intercept b and the RGS are in linear law, with the specific formula shown below:

$${AGB}_{i} = k * EVI 2 + b ; k = {k}_{1} \cdot {e}^{{b}_{1} \cdot RGS} ; \\ b = {k}_{2} * RGS + {b}_{2} ; EVI 2 = \frac{2.5 * ( NIR - R )}{1 + NIR + 2.4 * R}$$

wherein AGBᵢ refers to a crop biomass, k and b refer to a coefficient and an intercept of a first-layer regression equation of the biomass model of the whole growth period, wherein k and b are used as dependent variables of two regression equations respectively in the second layer of the model; EVI2 is an enhanced vegetation index which is a dependent variable of the first-layer model and calculated by a red band and a near-infrared band of remote-sensing images; NIR and R are a near-infrared band and a red band of remote-sensing images respectively; k₁, b₁, k₂ and b₂ refer to coefficients of two regression equations of the second layer respectively.

In the step S2, the biomass contribution rate curve is an allometric growth curve, with a horizontal axis being the relative accumulated temperature value and a vertical axis being a biomass contribution rate; by using the biomass of an image obtaining date and the biomass contribution rate curve, a crop harvest biomass is obtained as crop maximal biomass AGBₘₐₓ, wherein the crop maximal biomass AGBₘₐₓ and the biomass contribution rate are shown below:

$$β = \frac{{b}_{3}}{1 + {b}_{4} \times {e}^{{b}_{5} \cdot RGS}} ; {AGB}_{max} = \frac{AGB}{β}$$

wherein β is a biomass contribution rate, b₃, b₄, b₅ are model coefficients; AGBₘₐₓ is a crop final biomass; AGB is a biomass of crop in a growth period.

In the step S3, the crop yield is a biomass of the last day in the growth period multiplied by a harvest index; the harvest index is a harvest index of a region determined, with one county administrative region as unit, based on the characteristics of different crop varieties obtained from seed administration department or agriculture promotion department, wherein the yield prediction formula is as below:

$$Yield = {AGB}_{max} \times HI$$

in the formula, Yield refers to a crop yield and HI refers to a harvest index corresponding to a crop.

In the step S4, seven parameters k₁, b₁, k₂, b₂, b₃, b₄, b₅ and two independent variables VI and RGS of a crop remote-sensing yield estimation model are obtained, wherein VI refers to a remote-sensing vegetation index, and the seven parameters of the yield estimation model are optimized based on genetic optimization algorithm.

The step S4 comprises the following steps:
S4.1, performing parameter initialization and determining a parameter optimization range; using parameters of a CBA model built based on ground data as initial values of the parameters of the yield estimation model, wherein the CBA model is a biomass estimation model of a whole growth period;
S4.2 fitness calculation: when performing optimization on the parameters of the crop yield estimation model based on genetic algorithm, selecting a RMSE of a measured yield and a predicted yield as fitness function; during the optimization process of the model parameters, using RMSE minimization after performing yield estimation with the yield estimation model by using training data as optimization target:
calculating an individual fitness as below:

$$J = \sqrt{\frac{{\sum }_{i = 1}^{n} ( {Y}_{gai} - {Y}_{i} )}{n}}$$

wherein J is an individual fitness, n is a number of training samples, Y_{gai} is a yield estimation value of a sample point, and Y is a measured yield value of a sample point;
S4.3 iterative calculation: using the fitness function to perform fitness evaluation on an individual; based on a probability that the genetic algorithm is in direct proportion to the individual fitness, determining a chance that each individual in current population is passed down to a next-generation population, and based on a size of the individual fitness, performing reproduction, crossover and inheritance operations;
performing repetitive iterative operation on the model parameters; when adjacent iterations are <0.01 or reach a preset 500 iterations, ending iterative calculation; performing decoding on optimized individuals to obtain optimized model parameter values;
S4.4, crop yield estimation: bringing the obtained optimized parameter values into the yield estimation model, and with the relative accumulated temperature and the remote-sensing vegetation index EVI2 of a crop in any growth period as inputs, obtaining a yield estimation result by using the yield estimation model at different times.

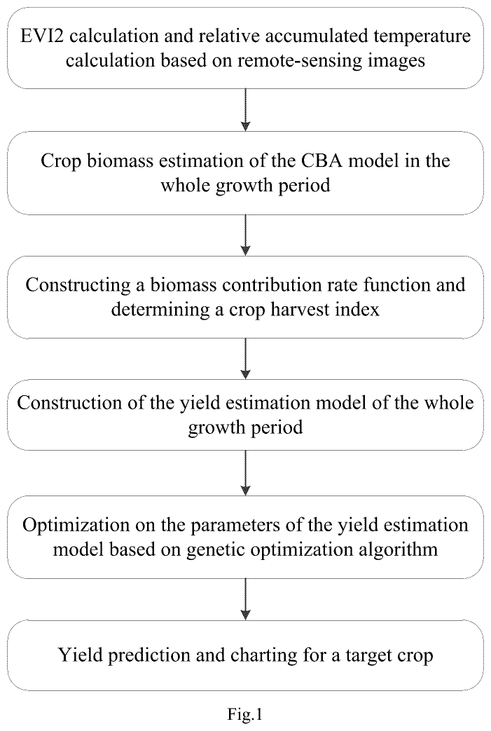

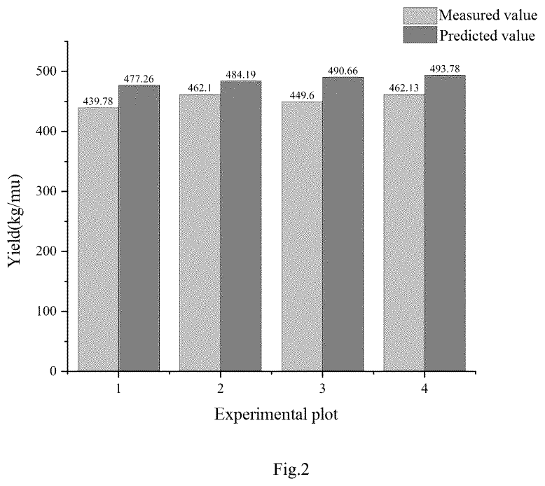

The flowchart of the CBA model of the present disclosure is as shown in FIG. 1. The rice yield prediction model constructed in the present disclosure has strong inter-annual extensibility and spatial universality and can achieve accurate prediction on the rice yield. Use of the relative growth period (RGS) as input parameter of the rice model means that as long as local calibration is performed, the rice model can be transferred to another region and a different season. In the present disclosure, analysis is performed on rice yield data of a first experimental area and a second experimental area. In the present disclosure, the yield model is constructed, and the RMSE of the measured value and the predicted value is 33 kg/mu, and finally, the theme diagrams of the rice yields of the two areas are as shown in FIG. 2. The yields of the first experimental area and the second experimental area are calculated by using non-farmland regions of the arable land to obtain average values which are about 428 kg/mu and 490 kg/mu respectively (there may be other crops in the arable land, and no consideration is given to the specific rice categories). The average rice yield of the second experimental area is higher than that of the first experimental area. The reason why the above different cases appear may be that different temperature changes of different regions have influences on the growth of the rice, leading to difference in rice quality. The modeling and verification accuracy of the model constructed in the present disclosure has obvious advantage over the inversion accuracy of the existing models, and the inter-annual and spatial extensibility of the model are verified. The model input data is relatively simple, and therefore, on-site instruments of these data can be easily developed and generated. The model is applicable to performing yield prediction for multiple time points of the rice growth to direct each management stage of the production process and the rice yield prediction.

The above embodiments are merely used to describe the technical solutions of the present disclosure rather than limit the present disclosure. Although detailed descriptions are made to the present disclosure by referring to the preceding embodiments, those skilled in the art should understand that the technical solutions recorded in the above embodiments may be modified or all or part of technical features thereof may be equivalently substituted. Such modifications or substitutions will not cause the essences of the corresponding technical solutions to depart from the scopes of the technical solutions of various embodiments of the present disclosure.

1-6. (canceled)

7. A remote-sensing yield estimation method applicable to a crop whole growth period, comprising:
S1: constructing a biomass estimation model of the whole growth period;
S2: constructing a biomass contribution rate curve;
S3: predicting crop yield; and
S4: performing parameter optimization of optimization algorithm;
wherein in the step S1, the biomass estimation model of the whole growth period is a layered structure, wherein in a first layer, a relationship model of an enhanced vegetation index EVI2 and biomass AGB is constructed; in a second layer, an evolution function is constructed with a coefficient of the first-layer model and a relative accumulated temperature of the growth period; a slope k of the first-layer model and the relative accumulated temperature RGS are in exponential law, and an intercept b and the RGS are in linear law, with the specific formula shown below:
$${AGB}_{i} = k * EVI 2 + b ; k = {k}_{1} \cdot {e}^{{b}_{1} \cdot RGS} ; \\ b = {k}_{2} * RGS + {b}_{2} ; EVI 2 = \frac{2.5 * ( NIR - R )}{1 + NIR + 2.4 * R} \underline{;}$$
wherein AGBᵢ refers to a crop biomass, k and b refer to a coefficient and an intercept of a first-layer regression equation of the biomass estimation model of the whole growth period, wherein k and b are used as dependent variables of two regression equations respectively in the second layer of the model; EVI2 is the enhanced vegetation index which is a dependent variable of the first-layer model and calculated by a red band and a near-infrared band of remote-sensing images; NIR and R are a near-infrared band and a red band of remote-sensing images respectively; k₁, b₁, k₂ and b₂ refer to coefficients of two regression equations of the second layer respectively;
in the step S2, the biomass contribution rate curve is an allometric growth curve, with a horizontal axis being the relative accumulated temperature value and a vertical axis being a biomass contribution rate; by using the biomass of an image obtaining date and the biomass contribution rate curve, a crop harvest biomass is obtained as crop maximal biomass AGBₘₐₓ, wherein the crop maximal biomass AGBₘₐₓ and the biomass contribution rate are shown below:
$$β = \frac{{b}_{3}}{1 + {b}_{4} \times {e}^{{b}_{5} \cdot RGS}} ; {AGB}_{max} = \frac{AGB}{β} \underline{;}$$
wherein β is a biomass contribution rate, b₃, b₄, b₅ are model coefficients; AGBₘₐₓ is a crop final biomass; AGB is a biomass of crop in a growth period;
in the step S3, the crop yield is a biomass of the last day in the growth period multiplied by a harvest index; the harvest index is a harvest index of a region determined, with one county administrative region as unit, based on the characteristics of different crop varieties obtained from seed administration department or agriculture promotion department, wherein the yield prediction formula is as below:
$$Yield = {AGB}_{max} \times HI ;$$
in the formula, Yield refers to a crop yield and HI refers to a harvest index corresponding to a crop;
in the step S4, seven parameters k₁, b₁, k₂, b₂, b₃, b₄, b₅ and two independent variables EVI2 and RGS of the biomass estimation model of whole growth period are obtained, wherein EVI2 refers to the enhanced vegetation index, and the seven parameters of the yield estimation model are optimized based on genetic optimization algorithm;
the step S4 comprises the following steps:
S4.1, performing parameter initialization and determining a parameter optimization range;
using parameters of a CBA model built based on ground data as initial values of the parameters of the yield estimation model, wherein the CBA model is the biomass estimation model of the whole growth period;
S4.2 fitness calculation: when performing optimization on the parameters of the biomass estimation model of the whole growth period based on genetic algorithm, selecting a RMSE of a measured yield and a predicted yield as fitness function; during the optimization process of the model parameters, using RMSE minimization after performing yield estimation with the yield estimation model by using training data as optimization target:
calculating an individual fitness as below:
$$J = \sqrt{\frac{{\sum }_{i = 1}^{n} ( {Y}_{gai} - {Y}_{i} )}{n}} ;$$
wherein J is an individual fitness, n is a number of training samples, Y_{gai} is a yield estimation value of a sample point, and Y is a measured yield value of a sample point;
S4.3 iterative calculation: using the fitness function to perform fitness evaluation on an individual; based on a probability that the genetic algorithm is in direct proportion to the individual fitness, determining a chance that each individual in current population is passed down to a next-generation population, and based on a size of the individual fitness, performing reproduction, crossover and inheritance operations;
performing repetitive iterative operation on the model parameters; when two adjacent iterations are <0.01 or reach a preset 500 iterations, ending iterative calculation; performing decoding on optimized individuals to obtain optimized model parameter values; and
S4.4, crop yield estimation: bringing the obtained optimized parameter values into the yield estimation model, and with the relative accumulated temperature and the enhanced vegetation index EVI2 of a crop in any growth period as inputs, obtaining a yield estimation result by using the yield estimation model at different times.

8. The remote-sensing yield estimation method of claim 7, further comprising:
S5, directing an optimized cultivation of the crop at each management stage of the crop whole growth period based on the yield estimation result.
